(19) United States
(12) Patent Application Publication
(10) Pub. No.: US 2009/0235192 A1
(43) Pub. Date: Sep. 17, 2009

(54) USER INTERFACE, METHOD, AND COMPUTER PROGRAM FOR CONTROLLING APPARATUS, AND APPARATUS

(75) Inventors: Ido DE HAAN, Assen (NL); Rene HIN, Emmen (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/049,639

(22) Filed: Mar. 17, 2008

(51) Int. Cl. G06F 3/048

(52) U.S. Cl. 715/764

(57) ABSTRACT

A user interface is disclosed, comprising a sensor arranged to determine a spatial change, said user interface being arranged to control at least one function, wherein the function is controlled by said determined spatial change. Further, an apparatus, a method, and a computer program for controlling a function are disclosed.

### FIELD OF INVENTION

The present invention relates to a user interface, a method, and a computer program for controlling an apparatus, and such an apparatus.

### BACKGROUND OF INVENTION

In the field of user operation of apparatuses, e.g. on small handheld apparatuses, e.g. mobile phones or portable media players, and headsets for these having benefit of being operated, the problem of manipulating the apparatus that do not have room for input means for all the functions provided by the apparatus. This can be solved by navigating in menus where parameters of the functions can be set, if the apparatus is equipped with a graphical user interface. However, this implies other problems: control of functions that a user put timing constraints on, or operation when the user do not have ability to look at the apparatus. Such a function is volume control. Different approaches have been provided to control volume by small dedicated keys or a sliding key (jog/shuttle knob). A problem with this is that it might either be hard for the user to use very small keys, or that the keys require too much space on the small handheld apparatus. Another problem is that mechanical fitting of such keys can give secondary problems, such as at manufacturing the apparatus, maintaining apparatus quality, or design of the apparatus. Therefore, there is a demand for an approach that overcomes at least some of these problems.

### SUMMARY

Therefore, the inventor has found an approach that is both user intuitive and efficient also for small apparatuses. The basic understanding behind the invention is that this is possible if the user is provided to control functions directly independent on menu status by means not requiring outer user interface space. The inventor realized that a user is able to move the portable apparatus, which can be registered by the apparatus. Thus, the user can control one or more functions independent on menus and without dedicated keys.

According to a first aspect of the present invention, there is provided a user interface comprising a sensor arranged to determine a spatial change, said user interface being arranged to control at least one function, wherein the function is controlled by said determined spatial change.

The spatial change may comprise a linear movement. The spatial change can comprises a change in orientation. The function may be volume control of audio output.

The user interface may further comprise an enablement controller arranged to provide a control signal enabling control of the function. The enablement controller may be arranged to receive a enablement user input for providing the control signal. The enablement user input may be a predetermined spatial change to be determined prior to the determined spatial change used to control the function. The user interface may further comprise a further user actuatable element. The enablement user input may be a determined actuation of the further user actuatable element.

According to a second aspect of the present invention, there is provided an apparatus comprising a processor and a user interface controlled by the processor, the user interface comprising features according to the first aspect of the present invention.

The apparatus comprises a processor and a user interface connected to the processor. The user interface comprises a sensor arranged to determine a spatial change. The processor is arranged to control a function based on said determined spatial change.

The spatial change may comprise a linear movement. The spatial change may comprise a change in orientation. The function may be volume control of audio output.

The apparatus may further comprise an enablement controller arranged to provide a control signal enabling control of the function. The enablement controller may be arranged to receive an enablement user input for providing the control signal. The enablement user input may be a predetermined spatial change to be determined prior to the determined spatial change used to control the function. The apparatus may further comprise a further user actuatable element. The enablement user input may be a determined actuation of the further user actuatable element.

According to a third aspect of the present invention, there is provided a user interface method comprising determining a spatial change; and controlling a function based on the determined spatial change.

The determining of the spatial change may comprise determining a linear movement. The determining of the spatial change may comprise determining a change in orientation. The controlling of the function may comprise adjusting audio output volume.

The method may further comprise, prior to determining the spatial change, receiving an enablement user input; and providing a control signal enabling the controlling of the function. The receiving of the enablement user input may comprise detecting a predetermined spatial change prior to the determined spatial change used to control the function. The receiving of the enablement user input may comprise detecting a determined actuation of a further user actuatable element.

According to a fourth aspect of the present invention, there is provided a computer program comprising instructions, which when executed by a processor are arranged to cause the processor to perform the method according to the third aspect of the invention.

According to a fifth aspect of the present invention, there is provided a computer readable medium comprising program code, which when executed by a processor is arranged to cause the processor to perform the method according to the third aspect of the invention.

The computer readable medium comprises program code comprising instructions which when executed by a processor is arranged to cause the processor to perform determination of a spatial change; and control of a function based on the determined spatial change.

The program code instructions for determination of a spatial change may further be arranged to cause the processor to perform determination of a linear movement. The program code instructions for determination of a spatial change may further be arranged to cause the processor to perform determination of a change in orientation. The program code instructions for control of a function may further be arranged to cause the processor to perform adjustment of audio output volume.

The program code instructions may further arranged to cause the processor to perform, prior to determination of the spatial change, reception of an enablement user input; and provision of a control signal enabling the controlling of the function. The program code instructions for reception of the enablement user input may further be arranged to cause the processor to perform detection of a predetermined spatial change prior to the determined spatial change used to control the function. The program code instructions for reception of the enablement user input may further be arranged to cause the processor to perform detection of an actuation of a further user actuatable element.

### BRIEF DESCRIPTION OF DRAWINGS

FIGS. 1a to 1c illustrate a user interface according to embodiments of the present invention.

FIG. 2 illustrates a user interface according to an embodiment of the present invention.

FIG. 3 illustrates an operation of the apparatus according to an embodiment of the present invention.

FIG. 4 illustrates an input action on a user interface according to an embodiment of the present invention.

FIG. 5 illustrates an assignment of directions for operation according to an embodiment of the present invention.

FIG. 6 is a block diagram schematically illustrating an apparatus according to an embodiment of the present invention.

FIG. 7 is a flow chart illustrating a method according to an embodiment of the present invention.

FIG. 8 schematically illustrates a computer program product according to an embodiment of the present invention.

### DETAILED DESCRIPTION OF EMBODIMENTS

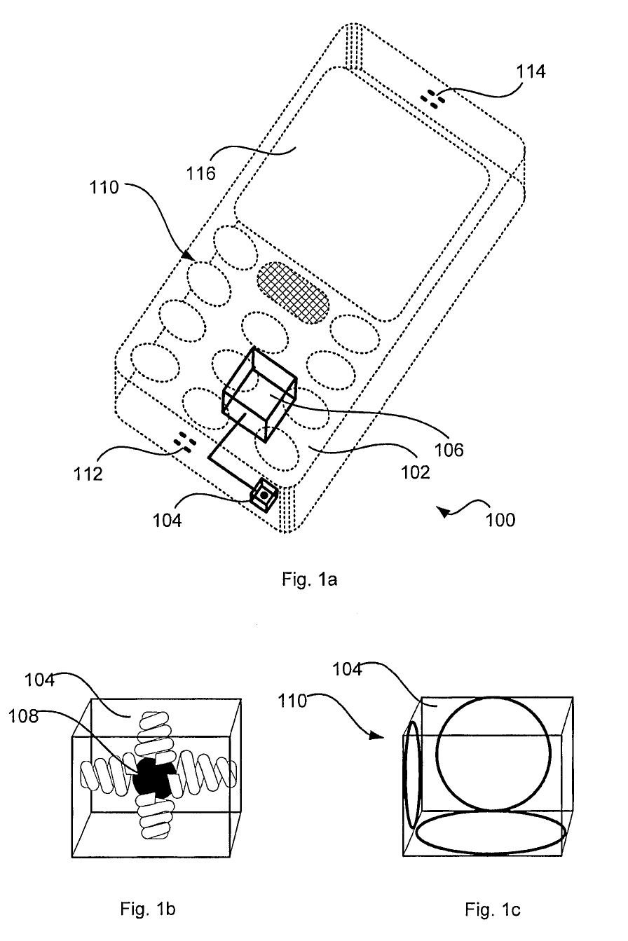

FIG. 1a illustrates a user interface 100 according to an embodiment of the present invention. The user interface 100 is illustrated in the context of an apparatus 102, drawn with dotted lines, holding an orientation sensor 104 of the user interface 100. The user interface 100 co-operates with a processor 106, which can be a separate processor of the user interface 100, or a general processor of the apparatus 102. The orientation sensor 104 can be a force sensor arranged to determine force applied to a seismic mass 108, e.g. integrated with the sensor 104, as schematically depicted magnified in FIG. 1b. By determining a direction and level of the force on the seismic mass 108, orientation and/or movement of the apparatus 102 can be determined. Alternatively, the orientation sensor 104 can be a gyroscopic sensor arranged to determine changes in orientation, e.g. a fibre optic gyroscope having fibre coils 110 in which light interference can occur based on movements, which then can be determined, as schematically depicted magnified in FIG. 1c. The orientation sensor 104 can be arranged to determine orientation in one or more dimensions. From the determined orientation and/or movement, user intentions can be derived, and control of functions, such as volume settings, can be done accordingly without menus or dedicated keys. In that way, a control, which can be fast, efficient, accurate and intuitive, is provided to the user.

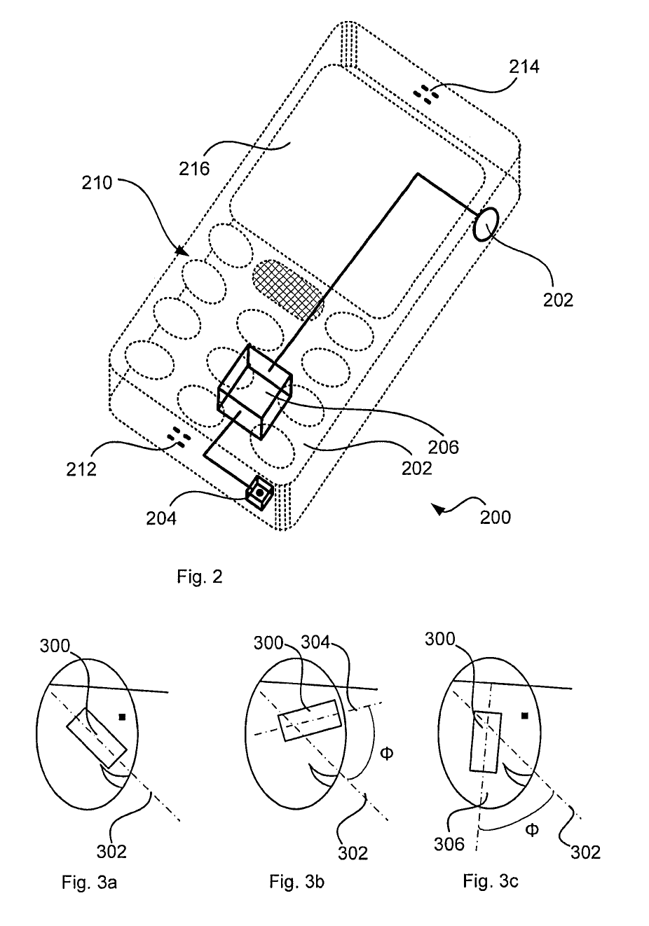

FIG. 2 illustrates a user interface 200 according to another embodiment of the present invention. The user interface 200 is illustrated in the context of an apparatus 202, drawn with dotted lines, holding the user interface 200. The user interface 200 comprises an orientation sensor 204, a processor 206, and an enablement input means 208, e.g. a key or proximity sensor. Any such actuatable user inputs 208 that are suitable for the apparatus 200 may be used. Similar to the embodiment of FIG. 1, from orientation and/or movement, user intentions can be derived, and control of functions, such as volume settings, can be done upon engagement of the enablement input means 208. This is particularly advantageous when directions and/or movements associated with operation control may be performed unintentionally, e.g. when using the apparatus while sporting or working. In that way, a fast, efficient, accurate and intuitive control is provided to the user also when physically active.

It should be noted that an accelerometer based on gyroscopic effects, or equivalent functioning sensor e.g. using optics and light interference, e.g. ring laser gyroscope or fibre optic gyroscope, can be used, as well as a force sensor and seismic mass to detect changes in orientation in the embodiment illustrated in FIG. 2. Input by means of the orientation sensor 204 is here only possible upon activation of the enablement input means 208.

The user interfaces 100, 200 may also comprise other elements, such as keys 110, 210, means for audio input and output 112, 114, 212, 214, image acquiring means (not shown), a display 116, 216, etc, respectively. The apparatuses 102, 202 may be a mobile telephone, a personal digital assistant, a navigator, a media player, a digital camera, or any other apparatus benefiting from a user interface according to any of the embodiments of the present invention.

Examples will be demonstrated below, but in general, the directions and/or movements can either be pre-set, or be user defined. In the latter case, a training mode can be provided where the user defines the directions and/or movements.

FIGS. 3a to 3c illustrate an operation example of an apparatus 300 according to an embodiment of the present invention. The apparatus 300 can for example be a mobile phone or a headset. The example is based on using the user interface demonstrated with reference to any of FIGS. 1a and 2. In this example, only the orientation of the apparatus 300 is considered, and in one dimension for the sake of easier understanding principles of the invention. However, the principle of considering the orientation can be used in several dimensions and degrees of freedom, and also in combination with movement considerations as demonstrated below.

The angles of orientation will be given as a deviation (D from a determined average orientation 302 of the present use of the apparatus, as illustrated in FIG. 3a, which can be determined by observing the orientation in e.g. a sliding time window function and providing the average orientation 302. The angle of deviation Φ can alternatively be defined from a predetermined standard orientation given in relation to e.g. plumb line. Upon registering a deviation Φ in orientation of about at least a certain threshold, e.g. +45 degrees, as illustrated in FIG. 3b, a user intention is derived and decoded by the processor, which control a function, e.g. audio volume to increase. Similar, upon registering another deviation Φ in orientation of about at least a certain threshold, e.g. −45 degrees, as illustrated in FIG. 3c, another user intention is derived and decoded by the processor, which control the function, e.g. audio volume to decrease.

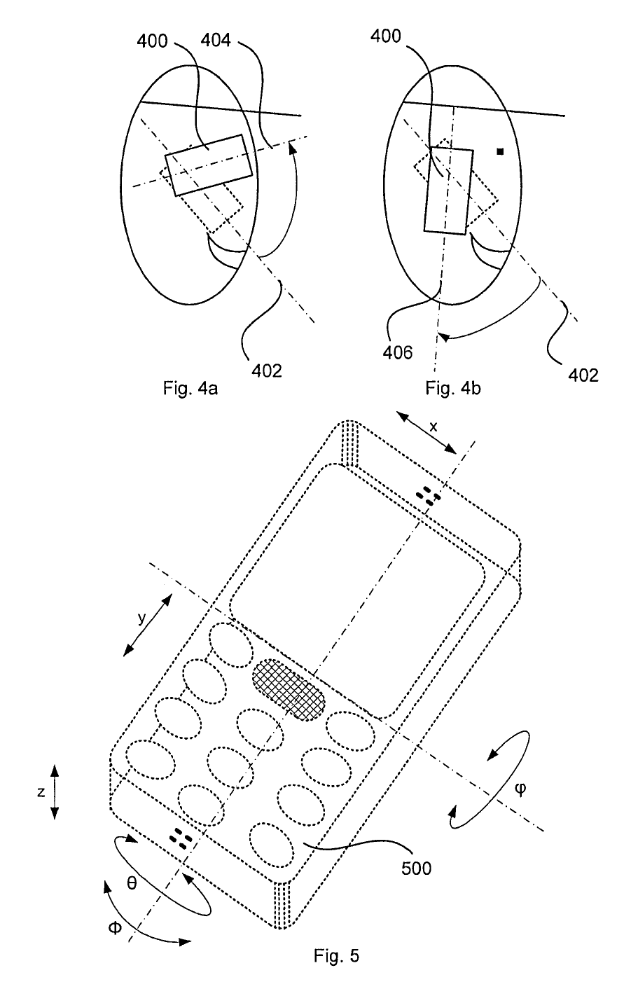

Another applicable principle is to determine movements of the apparatus. This relies on the fact that the force F on the seismic mass m depend on the acceleration of the mass as F=m·a. Upon movements, the seismic mass is subject to acceleration (and deceleration) in different directions, which movement can be registered by the force sensor and the processor. It should be noted that an accelerometer based on gyroscopic effects, or equivalent functioning sensor e.g. using optics and light interference to detect changes in orientation, e.g. ring laser gyroscope or fibre optic gyroscope. To illustrate this, FIG. 4a illustrates an input action on a user interface of an apparatus 400 according to an embodiment of the present invention indicated by arrowed line and which starts at a starting point depicted by the dotted apparatus 400 having a first orientation 402, wherein the apparatus 400 moves in the arrowed direction towards the position depicted by the apparatus 400 in solid lines having a second orientation 404. The movement can be registered by the user interface, and a corresponding control of function be made. FIG. 4b illustrates another input action indicated by arrowed line and which starts at a starting point depicted by the dotted apparatus 400 having a first orientation 402, wherein the apparatus 400 moves in the arrowed direction towards the position depicted by the apparatus 400 in solid lines having a third orientation 406. Also here, the movement can be registered by the user interface, and a corresponding control of function be made.

FIG. 5 illustrates assignments of changes in orientation and/or movements of an apparatus 500. The apparatus 500 is arranged with a user interface according to any of the embodiments demonstrated with reference to FIGS. 1 and 2. Movements can be determined from linear movements in any of the directions x, y or z, or any of them in combination. Movements can also be determined as change of orientation Φ, Θ, or φ, or any combination of them. Combinations between linear movement(s) and change of orientation(s) can also be made. From this, one or more functions can be controlled. As an example, a function can be controlled in two steps: first a detection of a change in orientation and/or movement is determined for enabling the control of the function, e.g. a twist changing orientation Θ or a back-and-forth movement along y, and second a determination of a change in orientation and/or movements for controlling the function, e.g. another twist changing orientation Φ or movement along x wherein a parameter of the function is changed according to the change in orientation Φ or movement along x. This sequence of change in orientation and/or movement can discriminate actual intentions to control the function from unintentional movements and changes in orientation of the apparatus 500.

In summary four main ways of operation principles can be employed. One is where the parameter to be controlled, e.g. sound volume, is derived from an angle deviation from a reference angle. Another is where an angle deviation above a threshold angle deviation causes stepwise increase or decrease, depending on if the angle deviation is positive or negative, of the parameter to be controlled. Further another is where the parameter to be controlled is derived from movement, i.e. determined acceleration, e.g. by stepwise increase or decrease, depending on the direction of movement, of the controlled parameter. Still further another is where the parameter to be controlled is derived in two steps: first where a movement indicates that a change is desired, and second where the amount of increase or decrease, depending on the direction of movement, is determined by the time the apparatus is kept in an orientation having an angle deviation above a threshold angle deviation. Different combinations of these main ways of operation can readily be employed to design the user interface.

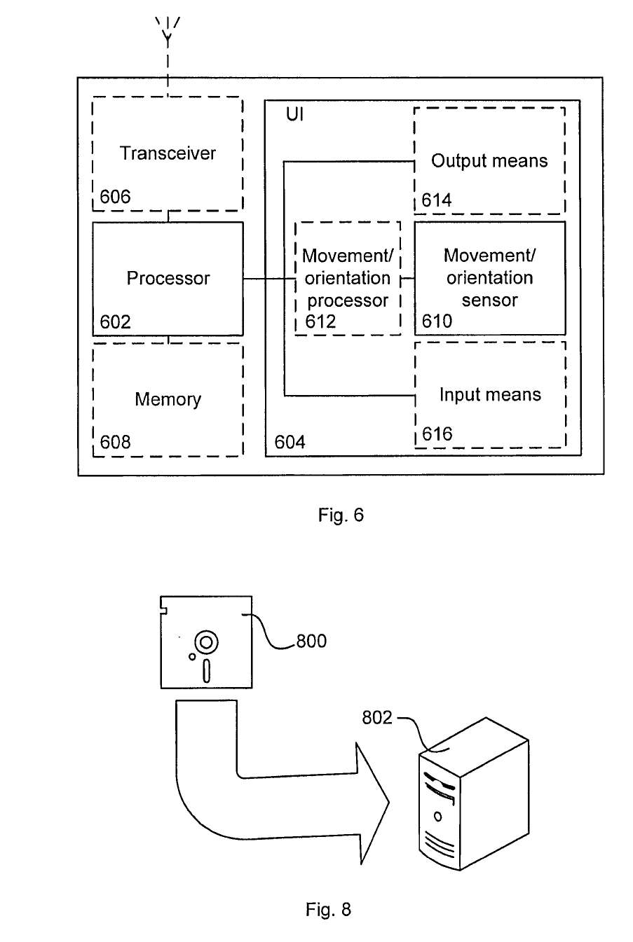

FIG. 6 is a block diagram schematically illustrating an apparatus 600 by its functional elements, i.e. the elements should be construed functionally and may each comprise one or more elements, or be integrated into each other. Broken line elements are optional and can be provided in any suitable constellation, depending on the purpose of the apparatus. In a basic set-up, the apparatus can work according to the principles of the invention with only the solid line elements. The apparatus comprises a processor 602 and a user interface UI 604 being controlled by the processor 602 and providing user input to the processor 602. The apparatus 600 can also comprise a transceiver 606 for communicating with other entities, such as one or more other apparatuses and/or one or more communication networks, e.g. via radio signals. The transceiver 606 is preferably controlled by the processor 602 and provides received information to the processor 602. The transceiver 606 can be substituted with a receiver only, or a transmitter only where appropriate for the apparatus 600. The apparatus can also comprise one or more memories 608 arranged for storing computer program instructions for the processor 602, work data for the processor 602, and content data used by the apparatus 600.

The UI 604 comprises at least a sensor 610 arranged to determine movements and/or orientations of the apparatus 600. Output of the sensor can be handled by an optional movement/orientation processor 612, or directly by the processor 602 of the apparatus 600. Based on the output from the sensor 610, the apparatus 600 can be operated according to what has been demonstrated with reference to any of FIGS. 1 to 5 above. The UI 604 can also comprise output means 614, such as display, speaker, buzzer, and/or indicator lights. The UI 604 can also comprise other input means, such as microphone, key(s), jog dial, joystick, and/or touch sensitive input area. These optional input and output means are arranged to work according to their ordinary functions.

The apparatus 600 can be a mobile phone, a portable media player, or other portable device benefiting from the user interface features described above. The apparatus 600 can also be a portable handsfree device or a headset that is intended to be used together with any of the mobile phone, portable media player, or other portable device mentioned above, and for example being in communication with these devices via short range radio technology, such as Bluetooth wireless technology. For headsets or portable handsfree devices, the user interface described above is particularly useful, since these devices normally are even smaller, and normally operated without any support from graphical user interfaces.

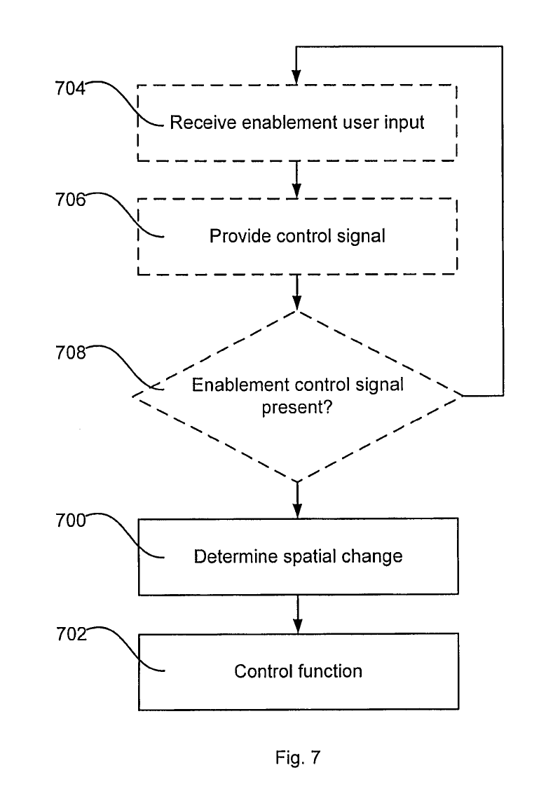

FIG. 7 is a flow chart illustrating a method according to an embodiment. The user interface method comprises determining 700 a spatial change. 16. The determining of the spatial change can comprise determining a linear movement and/or a change in orientation. The method further comprises controlling 702 a function based on the determined spatial change. The controlling 702 of the function can be adjusting audio output volume.

To avoid unintentional control of the function due to unintentional movements of an apparatus having a user interface performing the method, enablement control of controlling the function can be performed. This can be done, e.g. prior to determining the spatial change, by receiving 704 an enablement user input, and providing 706 a control signal enabling the controlling of the function. Where no enablement user input, e.g. detection of a predetermined spatial change or an actuation of a further user actuatable element such as a key or proximity sensor, is received, the method can wait until such enablement user input is received, e.g. by conditional return 708 to the reception phase 704 of enablement user input.

Upon performing the method, operation according to any of the examples given with reference to FIGS. 1 to 5 can be performed. The method according to the present invention is suitable for implementation with aid of processing means, such as computers and/or processors. Therefore, there is provided a computer program comprising instructions arranged to cause the processing means, processor, or computer to perform the steps of the method according to any of the embodiments described with reference to FIG. 7. The computer program preferably comprises program code which is stored on a computer readable medium 800, as illustrated in FIG. 8, which can be loaded and executed by a processing means, processor, or computer 802 to cause it to perform the method according to the present invention, preferably as any of the embodiments described with reference to FIG. 7. The computer 802 and computer program product 800 can be arranged to execute the program code sequentially where actions of the any of the methods are performed stepwise, but mostly be arranged to execute the program code on a real-time basis where actions of any of the methods are performed upon need and availability of data. The processing means, processor, or computer 802 is preferably what normally is referred to as an embedded system. Thus, the depicted computer readable medium 800 and computer 802 in FIG. 8 should be construed to be for illustrative purposes only to provide understanding of the principle, and not to be construed as any direct illustration of the elements.

1. A user interface comprising a sensor arranged to determine a spatial change, said user interface being arranged to control at least one function, wherein the function is controlled by said determined spatial change.

2. The user interface according to claim 1, wherein said spatial change comprises a linear movement.

3. The user interface according to claim 1, wherein said spatial change comprises a change in orientation.

4. The user interface according to claim 1, wherein said function is volume control of audio output.

5. The user interface according to claim 1, further comprising an enablement controller arranged to provide a control signal enabling control of the function, wherein the enablement controller is arranged to receive a enablement user input for providing the control signal.

6. The user interface according to claim 5, wherein the enablement user input is a predetermined spatial change to be determined prior to the determined spatial change used to control the function.

7. The user interface according to claim 5, further comprising a further user actuatable element, wherein the enablement user input is a determined actuation of the further user actuatable element.

8. An apparatus comprising a processor and a user interface connected to the processor, wherein the user interface comprises a sensor arranged to determine a spatial change, and the processor is arranged to control a function based on said determined spatial change.

9. The apparatus according to claim 8, wherein said spatial change comprises a linear movement.

10. The apparatus according to claim 8, wherein said spatial change comprises a change in orientation.

11. The apparatus according to claim 8, wherein said function is volume control of audio output.

12. The apparatus according to claim 8, further comprising an enablement controller arranged to provide a control signal enabling control of the function, wherein the enablement controller is arranged to receive an enablement user input for providing the control signal.

13. The apparatus according to claim 12, wherein the enablement user input is a predetermined spatial change to be determined prior to the determined spatial change used to control the function.

14. The apparatus according to claim 12, further comprising a further user actuatable element, wherein the enablement user input is a determined actuation of the further user actuatable element.

15. A user interface method comprising
determining a spatial change; and
controlling a function based on the determined spatial change.

16. The method according to claim 15, wherein determining the spatial change comprises determining a linear movement.

17. The method according to claim 15, wherein determining the spatial change comprises determining a change in orientation.

18. The method according to claim 15, wherein controlling the function comprises adjusting audio output volume.

19. The method according to claim 15, further comprising, prior to determining the spatial change,
receiving an enablement user input; and
providing a control signal enabling the controlling of the function.

20. The method according to claim 19, wherein receiving the enablement user input comprises detecting a predetermined spatial change prior to the determined spatial change used to control the function.

21. The method according to claim 19, wherein receiving the enablement user input comprises detecting a determined actuation of a further user actuatable element.

22. A computer readable medium comprising program code comprising instructions which when executed by a processor is arranged to cause the processor to perform
determination of a spatial change; and
control of a function based on the determined spatial change.

23. The computer readable medium according to claim 22, wherein the program code instructions for determination of a spatial change is further arranged to cause the processor to perform determination of a linear movement.

24. The computer readable medium according to claim 22, wherein the program code instructions for determination of a spatial change is further arranged to cause the processor to perform determination of a change in orientation.

25. The computer readable medium according to claim 22, wherein the program code instructions for control of a function is further arranged to cause the processor to perform adjustment of audio output volume.

26. The computer readable medium according to claim 22, wherein the program code instructions is further arranged to cause the processor to perform, prior to determination of the spatial change,
reception of an enablement user input; and
provision of a control signal enabling the controlling of the function.

27. The computer readable medium according to claim 26, wherein the program code instructions for reception of the enablement user input is further arranged to cause the processor to perform detection of a predetermined spatial change prior to the determined spatial change used to control the function.

28. The computer readable medium according to claim 26, wherein the program code instructions for reception of the enablement user input is further arranged to cause the processor to perform detection of an actuation of a further user actuatable element.
